(19) United States
(12) Patent Application Publication
(10) Pub. No.: US 2011/0182077 A1
(43) Pub. Date: Jul. 28, 2011

(54) Double Lamp Shade

(76) Inventors: Axel Meise, Munich (DE); Christoph Kügler, Munich (DE)

(21) Appl. No.: 12/936,010

(22) PCT Filed: Apr. 3, 2009
(86) PCT No.: PCT/EP09/54048

§ 371 Date: Apr. 8, 2011

(30) Foreign Application Priority Data
Apr. 4, 2008 (DE) 20 2008 017 240.5

(51) Int. Cl. F21V 11/00

(52) U.S. Cl. 362/351

(57) ABSTRACT

A light shade is presented for a modular lighting system, such as for example the Occhio® system of the applicant, with a coupling element for connection with a lamp support element, an at least translucent outer shade and a screen with zones of differing light transmittance within the outer shade, whereby the outer shade and the screen are each connected detachably and therefore optionally interchangeably with the coupling element.

The present invention relates to a light shade for a modular lighting system, with a coupling element to connect it with a lamp support element, an at least translucent outer shade and a screen with zones of differing light transmittance within the outer shade, as described in the patent claims.

Light shades for modular lighting systems are known and together with modular lighting systems themselves are in widespread use in building illumination. What is problematic here is that the respective light shades themselves can generally not be altered, so that when a change in appearance is desired it is necessary to install a completely new light shade, which is complex and hence cost-intensive. This is particularly problematic when lighting public properties, where alongside the lighting function the illumination systems not seldom also have to serve an information function, for instance by using certain colour coding to distinguish areas etc., as especially in modern, open architectures areas can change, so that the lighting has to change too.

There is thus a demand for light shades for modular lighting systems that can be changed to a great extent without this involving major fitting and installation outlay. The light shades should moreover be easy to manufacture and simple to handle.

A light shade is presented for a modular lighting system, such as for example the Occhio® system of the applicant, with a coupling element for connection with a lamp support element, an at least translucent outer shade and a screen with zones of differing light transmittance within the outer shade, wherein the outer shade and the screen are each connected to the coupling element in a manner such that they can be interchanged as desired.

Through the arrangement of the screen within the outer shade it is possible to produce light patterns on the outer shade, depending on the design or position of the screen, that can either have a decorative character if they are used in the private sector, or an informative character too if they are used in the public sector. Thanks to the detachable and hence interchangeable connection of both outer shade and screen with the coupling element, a sheer infinite number of combinations in the appearance of the lamps can be achieved via appropriate combination of colour and transparency or translucence of the outer shade with correspondingly styled screens. The lamp can thus be individualised to a very large degree.

The outer shade and the screen can preferably be plugged in the coupling element in order to enable the easiest possible interchangeability and combining capability of the respective elements. The connection between the coupling element and the outer shade and/or the screen is preferably a bayonet-type connection.

In order to change the impression given by the lamp or its information content, a new combination can be produced by simply plugging and unplugging the outer shade and screen anew without involving any major fitting and installation work.

It is further preferable, though not necessary, for the outer shade to be spherically formed and the screen to be essentially arranged concentrically to the outer shade.

In a preferred embodiment the screen displays an outlet in at least one section or on at least one side to allow light to pass unimpeded from a light source to the outer shade.

The screen can advantageously display a trunk for connection with the coupling element and a head that can still be preferably spherical and that is cut open on at least one side to form the zones of differing light transmittance, so that a closed screen with outlets results through which the light can pass unimpeded. The spherical head of the screen can be connected interchangeably with the trunk of the screen in order to create a further possible combination option.

It is further preferable that the coupling element is equipped on the one hand with engaging devices for fixing on the lamp support element, and on the other hand with threaded pins for fixing the outer shade and screen to the coupling element.

The light shade is preferably designed such that the outer shade displays an at least translucent main shade and a fitting for connection with the coupling element in which the main shade is held.

The coupling element, the screen and the fitting are made of an identical material, such as for example metal. The main shade of the outer shade by contrast is preferably made of glass, although however suitable plastics could also enter into question.

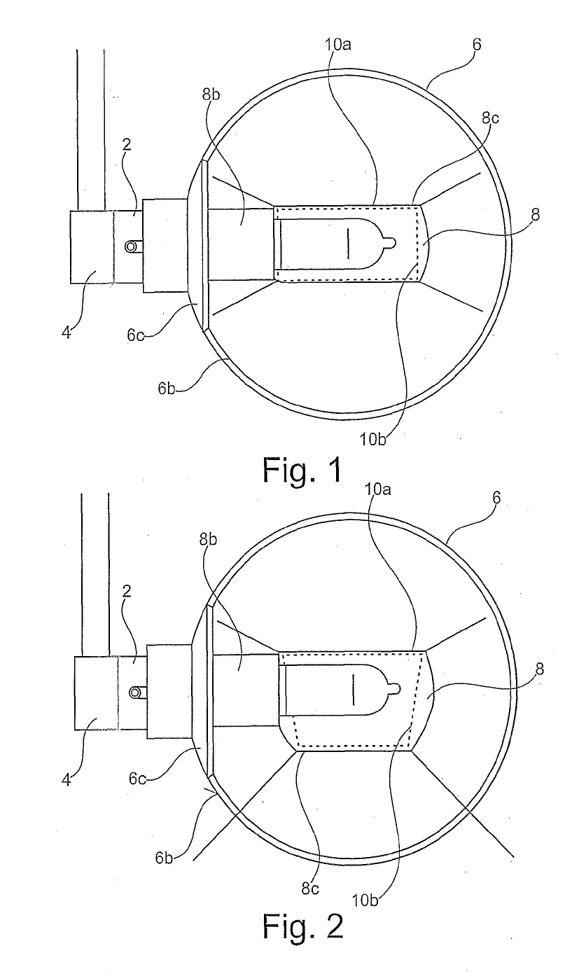

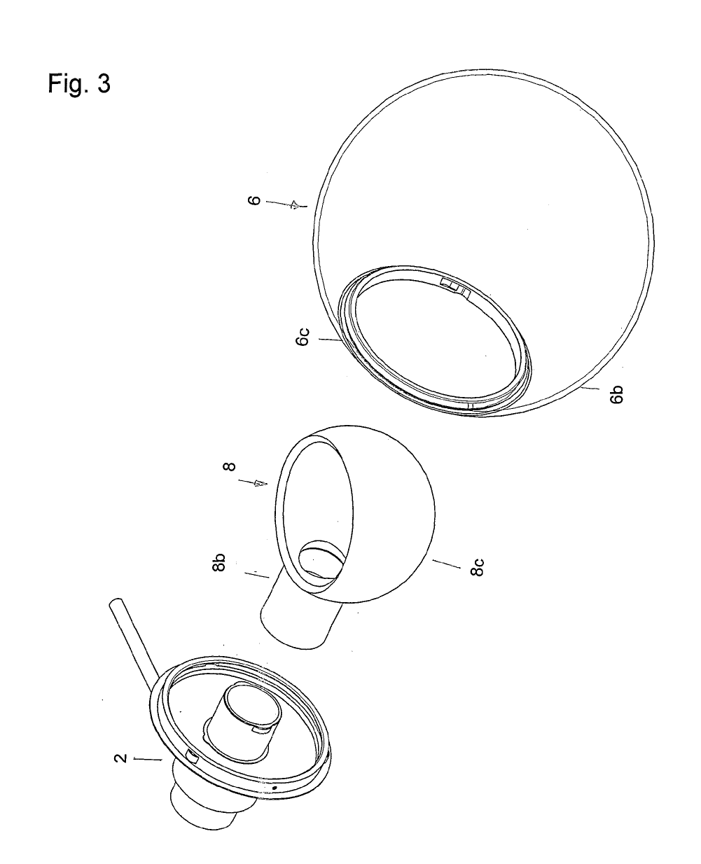

Further properties and advantages of the invention result from the following description of a preferred embodiment with reference to the attached FIG. 1, FIG. 2 and FIG. 3.

The figures show a light shade for a modular lighting system, such as for example the Occhio® system of the applicant, with a coupling element (2) for connection with a lamp support element (4), an at least translucent outer shade (6) and a screen (8) with zones of differing light transmittance (10a, 10b) within the outer shade (6), whereby the outer shade (6) and the screen (8) are each connected detachably and hence optionally interchangeably with the coupling element (2).

The outer shade (6) and the screen (8) are here designed such that they can be plugged on the coupling element (2) in order to enable the easiest possibly exchangeability and combination capability of the respective elements. As can be seen in FIG. 3, in the practical embodiment shown the outer shade (6) and the screen (8) can be attached to the coupling element (2) with a bayonet-type fastening.

As can be seen from the figures, the outer shade (6) is designed spherically and the screen (8) is arranged essentially concentrically to the outer shade (6).

The screen (8) possesses a trunk (8b) for connection with the coupling element (2) and a head (8c), that is preferably formed essentially spherically. The head (8c) can display an outlet in at least one section, through which the light from a light source arranged inside the screen (8) can pass to the outer shade (6). Thus the head (8c) can be a hollow spherical cap-type or a hollow spherical layer-type body. In the practical embodiment shown, the head (8c) is designed spherically and cut open on two sides, namely the top and bottom, so that a closed screen with outlets results, through which the light can pass unimpeded. The spherical head (8c) of the screen can be connected interchangeably with the trunk (8b) of the screen.

The coupling element (2) displays engaging devices (not shown) for fixing to the lamp support element (4), and on the other hand threaded pins (not shown) for fixing the outer shade (6) and screen (8) to the coupling element (4). In the practical embodiment shown in FIGS. 1 and 2, the outer shade (6) and screen (8) are plugged on the coupling element (2), whereby other variants too are conceivable, such as inserting in the coupling element (2).

In the practical embodiment shown, the outer shade (6) has an at least translucent main shade (6b) and a fitting (6c) for connection with the coupling element (2), in which the main shade (6b) is held.

Preferably there is a space between the (inner) head (8c) and the (outer) main shade (6b), so that an intermediate gap is formed between the head (8c) and the main shade (6b) when the light shade is assembled.

The coupling element (2), the screen (8) and the fitting (6c) are made of metal, while the main shade (6b) of the outer shade is made of glass.

1. A light shade for a modular lighting system, comprising a coupling element for connection with a lamp support element, an at least translucent outer shade and a screen with zones of differing light transmittance within the outer shade, that are each connected detachably with the coupling element.

2. A light shade according to claim 1, wherein the outer shade and the screen can be plugged interchangeably on the coupling element.

3. A light shade according to claim 1, wherein the outer shade is spherical and the screen is arranged essentially concentrically to the outer shade.

4. A light shade according to claim 1, wherein the screen displays an outlet on at least one section in order to allow light from a light source to pass unimpeded to the outer shade.

5. A light shade according to claim 1, wherein the screen displays a trunk for connection with the coupling element and an essentially spherical head that is cut open on at least one side to form the zones of differing light transmittance.

6. A light shade according to claim 5, wherein the spherical head of the screen is connected interchangeably with the trunk of the screen.

7. A light shade according to claim 1, wherein the coupling element can be plugged over or in the lamp support element.

8. A light shade according to claim 1, wherein the coupling element displays engaging devices for fixing to the lamp support element.

9. A light shade according to claim 1, wherein the coupling element displays threaded pins for fixing the outer shade and screen in their plugged condition.

10. A light shade according to claim 1, wherein the outer shade displays an at least translucent main shade and a fitting for connection with the coupling element, in which the main shade is held.

11. A light shade according to claim 1, wherein the coupling element, screen and fitting are made of an identical material.

12. A light shade according to claim 10, wherein the coupling element, screen and fitting are made of metal and that the main shade is made of glass.

13. A light shade according to claim 1, wherein the connection between the coupling element and the outer shade and/or screen is a bayonet-type connection.

14. A light shade according to claim 1, wherein there is a space between a head of the screen and a main shade of the outer shade in order to form an intermediate gap between the head and the main shade when the light shade is assembled.
